(19) United States
(12) Patent Application Publication
(10) Pub. No.: US 2020/0158258 A1
(43) Pub. Date: May 21, 2020

(54) OPENING AND CLOSING VALVE

(71) Applicant: AISIN SEIKI KABUSHIKI KAISHA, Kariya-shi (JP)

(72) Inventors: Koichi MARUYAMA, Kariya-shi (JP); Naoto YUMISASHI, Kariya-shi (JP); Masafumi YOSHIDA, Kariya-shi (JP); Hideyuki SUZUKI, Kariya-shi (JP)

(73) Assignee: AISIN SEIKI KABUSHIKI KAISHA, Kariya-shi (JP)

(21) Appl. No.: 16/688,027

(22) Filed: Nov. 19, 2019

(30) Foreign Application Priority Data
Nov. 19, 2018 (JP) 2018-216816

(51) Int. Cl. F16K 47/02; F16K 1/04; F16K 31/04

(52) U.S. Cl. CPC F16K 47/023; F16K 31/04; F16K 1/04

(57) ABSTRACT

An opening and closing valve includes: a housing that has an internal space formed to have a posture along an axis and has inflow and outflow ports communicating with each other via the internal space; a valve body that is switchable between a closed position where flow of a fluid between the inflow and outflow ports is blocked and an open position where the flow of the fluid between the inflow and outflow ports is allowed, by being operated in the internal space along the axis; a direct current motor that operates the valve body in a direction along the axis; and a damper unit that decreases a moving speed of the valve body immediately before the valve body reaches at least one of the open and closed positions by a drive force of the direct current motor.

### CROSS REFERENCE TO RELATED APPLICATIONS

This application is based on and claims priority under 35 U.S.C. § 119 to Japanese Patent Application 2018-216816, filed on Nov. 19, 2018, the entire contents of which are incorporated herein by reference.

### TECHNICAL FIELD

This disclosure relates to an opening and closing valve that controls flow of a fluid by opening and closing a valve body.

### BACKGROUND DISCUSSION

As an opening and closing valve (a cooling water amount control valve in JP 2006-29113A (Reference 1)), a technique of controlling a position of a valve body (a first spool valve in JP 2006-29113A) inside a housing by a drive motor to control the flow of cooling water circulating between an engine and a radiator is disclosed in JP 2006-29113A.

In the opening and closing valve of JP 2006-29113A, the housing is configured by a tubular member, and a plurality of ports (a radiator-side passage and a pump-side passage) are formed in the housing. In addition, the valve body is movably accommodated in an internal space of the housing, and a threaded portion of a rotary shaft that is rotationally driven by the drive motor is screwed with the valve body.

Accordingly, it is possible to control the flow of cooling water between the plurality of ports by operating the valve body by a drive force of the drive motor.

In the opening and closing valve disclosed in JP 2006-29113A (Reference 1), since the flow rate of cooling water is controlled, a stepping motor that can perform rotation control is used as a drive motor. When the stepping motor is used, an opening degree of the valve body of the opening and closing valve can be changed, and the valve body can be reliably stopped at an open position where a flow passage is completely opened and a closed position where the flow passage is completely closed, without using a stopper.

Herein, when a configuration where the piston-shaped valve body is disposed inside the cylindrical housing is considered as an opening and closing valve, a communication bore that allows an inside and an outside of a piston to communicate with each other is necessary since an operation velocity of the valve body rises.

However, in a case where an affordable direct current motor such as a brushless DC motor is used instead of the stepping motor, rotation control cannot be performed. Therefore, when a configuration where the valve body is switchable between the two positions including the open position and the closed position is assumed as an opening and closing valve, a valve including an abutting structure such as a stopper that determines mechanical limitations to stop the valve body at the open position and the closed position is considered. However, for example, in a case where the opening and closing valve operates at a high speed and reaches an operating limit of any one of the open position and the closed position, generating an impact when the opening and closing valve abuts is also considered.

Thus, a need exists for an opening and closing valve which is not susceptible to the drawback mentioned above.

### SUMMARY

A feature of an opening and closing valve according to an aspect of this disclosure resides in that the opening and closing valve includes a housing that has an internal space formed to have a posture along an axis and has an inflow port and an outflow port which communicate with each other via the internal space, a valve body that is switchable between a closed position where flow of a fluid between the inflow port and the outflow port is blocked and an open position where the flow of the fluid between the inflow port and the outflow port is allowed, by being operated in the internal space of the housing along the axis, a direct current motor that operates the valve body in a direction along the axis, and a damper unit that decreases a moving speed of the valve body immediately before the valve body reaches at least one of the open position and the closed position by a drive force of the direct current motor.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a longitudinal sectional view of an opening and closing valve in which a valve body is at an open position;

FIG. 2 is a cross sectional view of parts of a housing and the valve body;

FIG. 3 is an enlarged sectional view illustrating a first damper unit at a time point immediately before the valve body is opened;

FIG. 4 is an enlarged sectional view illustrating the first damper unit at a time point when the valve body is at the open position;

FIG. 5 is a longitudinal sectional view of the opening and closing valve in which the valve body is at a closed position;

FIG. 6 is a cross sectional view of parts of an end bracket and a second protrusion;

FIG. 7 is an enlarged sectional view illustrating a second damper unit at a time point immediately before the valve body is closed;

FIG. 8 is a longitudinal sectional view illustrating a configuration of a second damper unit according to another Embodiment (a);

FIG. 9 is an enlarged sectional view illustrating the second damper unit at a time point when a valve body is at a closed position in another Embodiment (a);

FIG. 10 is a perspective view of a disc-shaped portion and a middle bracket in another Embodiment (a); and

FIG. 11 is an enlarged sectional view illustrating a first damper unit at a time point immediately before a valve body is closed in another Embodiment (b).

### DETAILED DESCRIPTION

Hereinafter, embodiments disclosed here will be described based on the drawings.

### Basic Configuration

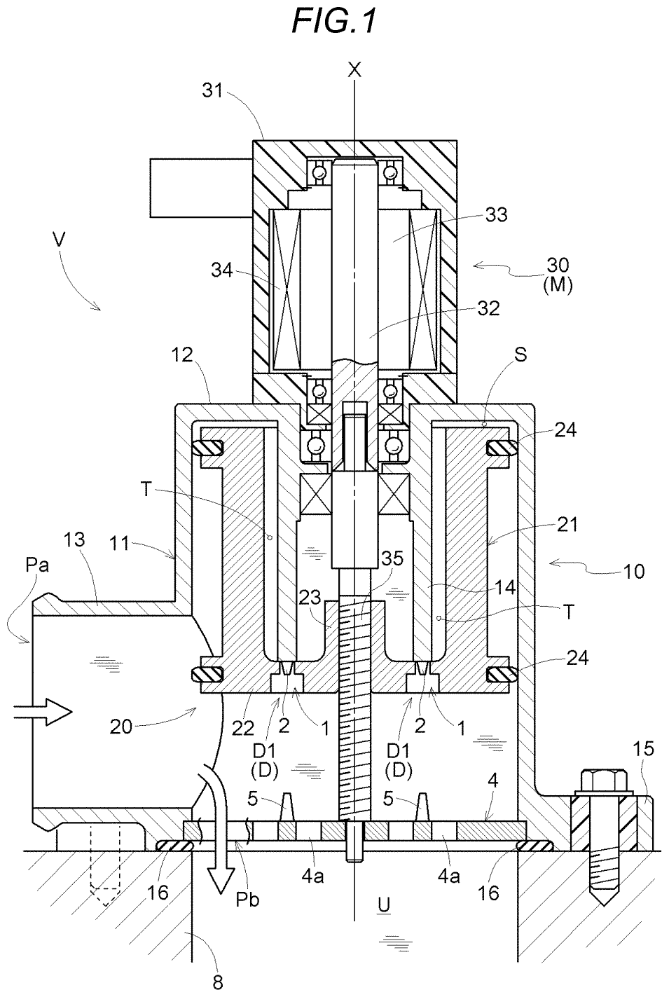

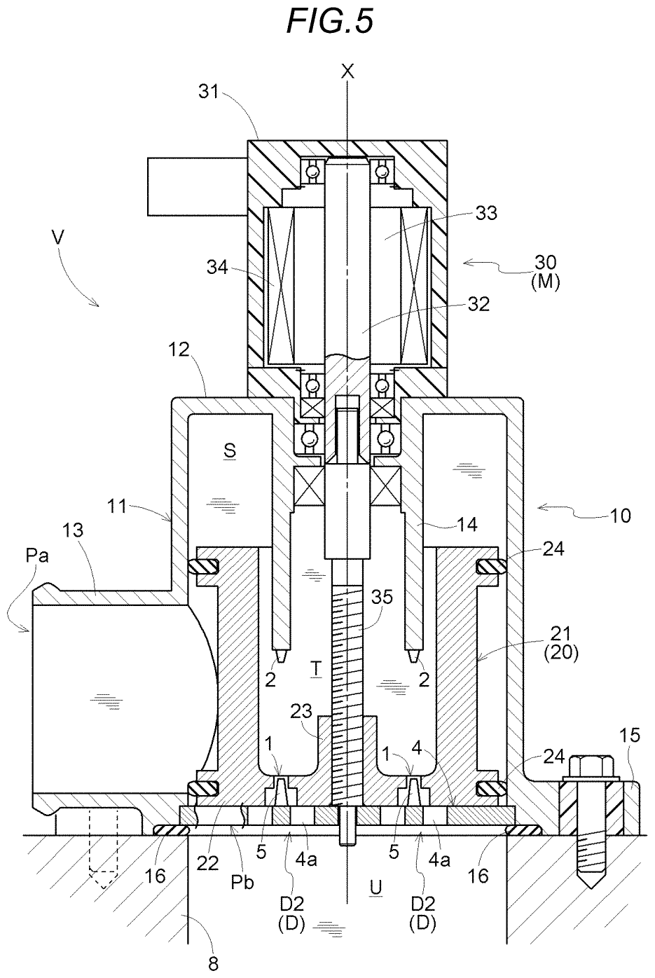

As illustrated in FIGS. 1 and 5, an opening and closing valve V is configured to include a housing 10, a valve body 20, and a drive mechanism 30 having a direct current motor M. The housing 10 and the valve body 20 of the opening and closing valve V may be formed of any material of a resin material and a metal material.

The opening and closing valve V is configured to make the valve body 20 switchable between an open position illustrated in FIG. 1 and a closed position illustrated in FIG. 5 to allow circulation of cooling water, which is a fluid, between an engine (not illustrated) and a radiator (not illustrated) in a vehicle that travels by a drive force of an internal combustion engine.

The valve body 20 is set to be switched to any one position of the open position and the closed position, and a control form thereof is set such that the direct current motor M is in forward rotation driving or reverse rotation driving for a time set in advance when moving between the two positions. Control of opening and closing the valve body 20 is performed based on detection by a water temperature sensor included in the engine.

The housing 10 includes an inflow port Pa and an outflow port Pb, and the opening and closing valve V is configured such that the drive mechanism 30 linearly operates the valve body 20 along an axis X. The opening and closing valve V may include three or more ports.

In a case where the valve body 20 is set at the closed position, the inflow port Pa and the outflow port Pb are maintained in a closed state, and in a case where the valve body 20 is set at the open position, the valve body functions to send out cooling water, which flows in from the inflow port Pa, from the outflow port Pb.

Since the open position and the closed position are disposed at an operating limit of the valve body 20, the opening and closing valve V includes a damper unit D that suppresses an impact when the valve body 20 has reached the operating limit (the closed position and the open position). The operating limit refers to a position of an end portion of a mechanically operable region. In the embodiment, in a case where the valve body 20 has reached the open position, the valve body 20 is fixed at the open position. On the other hand, when the valve body 20 has reached the closed position, some movement of the valve body 20 in a direction along the axis X is allowed by elastic deformation of an annular seal body 16.

Details of each unit of the opening and closing valve V including the configuration of the damper unit D will be described below.

### Housing

As illustrated in FIGS. 1, 2, 5, and 6, the housing 10 is integrally formed with a housing main body 11 having a tubular internal space S, of which a center is the axis X, and an end wall 12 disposed on one end portion (an upper end portion in FIGS. 1 and 5) of the housing main body 11. In addition, the inflow port Pa that communicates with the internal space S is formed by a branched tube 13 protruding from the housing main body 11 outwards, and in the housing main body 11, the outflow port Pb that communicates with the internal space S is formed on an opposite side to the end wall 12.

In the housing 10, a tubular sleeve 14 of which a center is the axis X is formed in the internal space S to protrude from an inner surface side of the end wall 12 toward the outflow port Pb. In the housing 10, a plurality of connecting units 15 protruding outwards (in a direction orthogonal to the axis X) in a flange shape from an outer circumferential portion of an end portion of the housing main body 11, in which the outflow port Pb is formed, is integrally formed with the housing main body 11.

### Valve Body

As illustrated in FIGS. 1, 2, 5, and 6. the valve body 20 is configured in a bottomed tubular shape by a disc-shaped portion 22 being integrally formed with an end portion of a cylindrical portion 21 formed with the axis X as a center thereof, the end portion opposing the outflow port Pb. In the internal space S, a space surrounded by the cylindrical portion 21 and the disc-shaped portion 22 will be referred to as an in-valve space T, and a space outside the disc-shaped portion 22 will be referred to as an out-valve space U. The in-valve space T and the out-valve space U are conceptually included in the internal space S of the housing main body 11.

In the valve body 20, a female screw portion 23, which is screwed with a screw shaft 35 integrally rotating with a shaft 32 of the drive mechanism 30, is integrally formed with the shaft at a middle position of the disc-shaped portion 22.

In addition, the valve body 20 is supported in a state where a seal ring 24 formed of an elastic material such as rubber is fitted in a mating groove formed in an outer circumference of each of both end portions thereof in the direction along the axis X, and an outer circumference of the seal ring 24 is in contact with an inner peripheral surface of the housing main body 11.

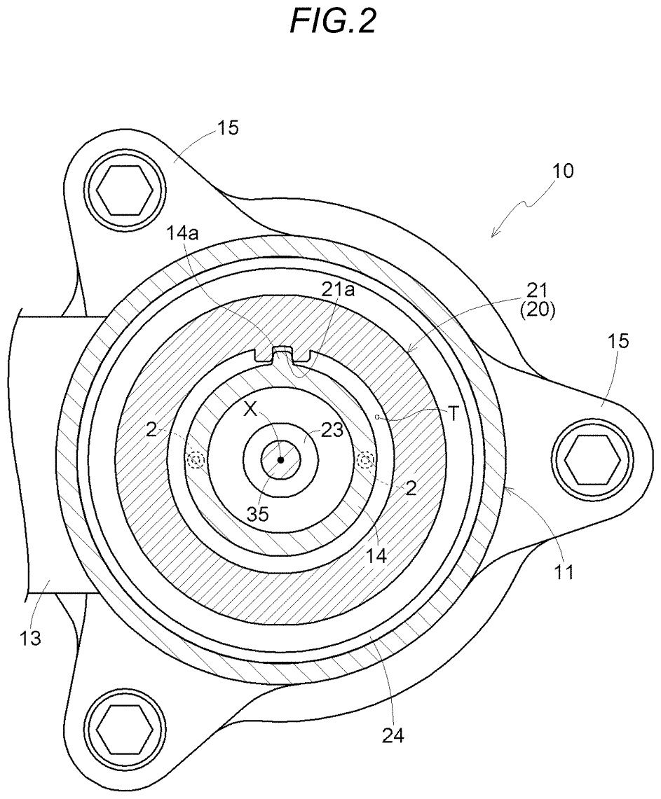

As illustrated in FIG. 2, a groove portion 21a is formed in a posture parallel to the axis X in an inner circumference of the cylindrical portion 21 in order to restrict the rotation of the valve body 20 when the screw shaft 35 rotates, and an engaging portion 14a that can be engaged with the groove portion 21a is protrudingly formed on an outer circumference of the sleeve 14.

As a configuration restricting the rotation of the valve body 20, for example, a protruding piece may be formed on an inner circumference of the valve body 20, and a groove-shaped portion that can be engaged with this protruding piece may be formed in the outer circumference of the sleeve 14 along the axis X. In addition, as a configuration restricting the rotation of the valve body 20, it is also possible to form a hole-shaped portion in the valve body 20 in a posture parallel to the axis X and to form a rod to be inserted in this hole-shaped portion inside the housing 10.

### Drive Mechanism

As illustrated in FIGS. 1 and 5, the direct current motor M is configured as a brushless DC motor of which the shaft 32, a rotor 33, and a stator 34 are accommodated inside a motor case 31.

That is, the direct current motor M includes the rotor 33 that has a permanent magnet, which supports the shaft 32 so as to freely rotate with respect to the motor case 31 and integrally rotates with the shaft 32, and the stator 34 having a field coil is disposed in a region surrounding the rotor 33. The direct current motor M is not limited to a brushless DC motor, and may be a DC motor using a brush.

As described above, the drive mechanism 30 is configured to include the direct current motor M and the screw shaft 35, which is disposed coaxially with the shaft 32 of the direct current motor M and is screwed with the female screw portion 23 of the valve body 20.

### Damper Unit

The opening and closing valve V is set to stop the valve body 20 at the two positions including the open position illustrated in FIG. 1 and the closed position illustrated in FIG. 5 by driving the direct current motor M for a time set in advance. The reason why time is controlled in this manner is that accurate rotation control is not possible by the direct current motor M. The damper unit D for decreasing a moving speed of the valve body 20 immediately before the valve body 20 reaches the open position and immediately before the valve body reaches the closed position and completely stopping the valve body 20 when the valve body 20 has reached the open position and the closed position based on such a drive form is included.

The damper unit D that decreases the moving speed immediately before the valve body 20 reaches the open position will be referred to as a first damper unit D1, and the damper unit D that decreases the moving speed immediately before the valve body 20 reaches the closed position will be referred to as a second damper unit D2. Although a configuration where the opening and closing valve V includes the first damper unit D1 and the second damper unit D2 respectively is shown in the embodiment, the opening and closing valve V may be configured to include only one of the first damper unit D1 and the second damper unit D2.

### Damper Unit: First Damper Unit

As illustrated in FIGS. 1 to 4, the first damper unit D1 includes a pair of through holes 1 formed in the disc-shaped portion 22 of the valve body 20 and a pair of first protrusions 2 formed on an extending end (a lower end in FIG. 1) of the sleeve 14 to be insertable into the through holes 1.

Not only in the first damper unit D1 but also in the second damper unit D2 to be described later, the through holes 1 function as a communicating structure that reduces a pressure difference between the in-valve space T of the valve body 20 and the out-valve space U when operating the valve body 20. In addition, by causing the through holes 1 to function as orifices in the damper unit D, the through holes function to increase the pressure difference between the in-valve space T and the out-valve space U and to decrease the moving speed of the valve body 20.

As a specific configuration, in an annular region overlapping the sleeve 14 when seen from the direction along the axis X, the through holes 1 are formed in two places opposing each other with the axis X interposed therebetween. The through holes 1 are circular when seen from the direction along the axis X, and each are formed in a shape in which an out-valve side diameter from a middle portion in a thickness direction of the disc-shaped portion 22 to a position of an outer surface of the disc-shaped portion 22 is larger than an in-valve side diameter from the in-valve space T to the middle portion.

In addition, the first protrusions 2 each have a tapered tip of which a diameter decreases as going toward an extension side (a lower side in FIG. 1) of the sleeve 14, and even a part thereof having the largest diameter has a diameter smaller than an inner diameter of each of the through holes 1 on a side of the in-valve space T.

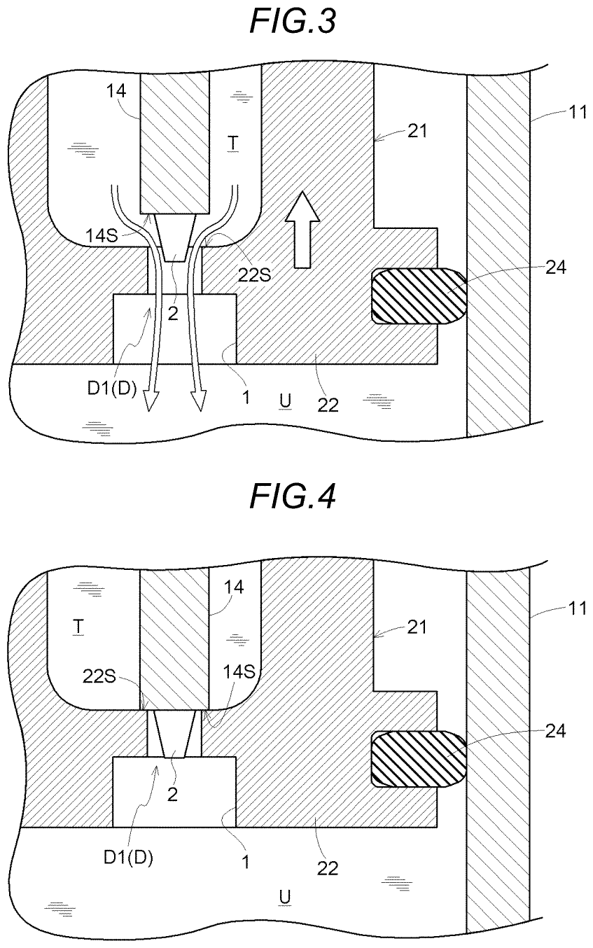

As illustrated in FIGS. 3 and 4, in the first damper unit D1, a part of the disc-shaped portion 22, which surrounds each of the through holes 1, the part being exposed to the in-valve space T, is set as an internal seal surface 22S, which is a smooth surface orthogonal to the axis X, and a part of the extending end of the sleeve 14, which surrounds each of the first protrusions 2, is set as a first seal surface 14S, which is a smooth surface orthogonal to the axis X.

Due to this configuration, in a case where the valve body 20 is operated from the closed position toward the open position, a pressure difference between cooling water in the in-valve space T and cooling water in the out-valve space U rarely occurs since the cooling water in the in-valve space T flows to the out-valve space U via the through holes 1, and thus it is possible to smoothly operate the valve body 20. Due to this operation, in a case where the valve body 20 has approached the open position as illustrated in FIG. 3, protruding end portions of the first protrusions 2 come closer to and enter the through holes 1, and cause the through holes 1 to function as orifices. Therefore, a pressure of the cooling water in the in-valve space T becomes larger than a pressure of the cooling water in the out-valve space U, the flow rate of cooling water flowing through the through holes 1 is reduced, and also the moving speed of the valve body 20 decreases.

After this operation, immediately before the valve body 20 reaches the open position, an interval between the first seal surface 14S and the internal seal surface 22S is extremely small, and the flow of cooling water in this part is limited. As a result, the moving speed of the valve body 20 significantly decreases, a position of the valve body 20 is determined by the first seal surface 14S and the internal seal surface 22S abutting against each other in the end as illustrated in FIG. 4, and the valve body 20 is maintained at the open position.

### Damper Unit: Second Damper Unit

As illustrated in FIGS. 5 to 7, the second damper unit D2 includes the pair of through holes 1 formed in the disc-shaped portion 22 of the valve body 20, an end bracket 4 that is supported to be non-rotatable relatively to the housing main body 11, and a pair of second protrusions 5 formed to protrude on the end bracket 4 in a positional relationship in which the second protrusions are insertable into the pair of through holes 1.

As a specific configuration, the through holes 1, which are the same as the through holes used in the first damper unit D1, are used. When the valve body 20 has reached the closed position, the end bracket 4 is disposed at a position where an outer surface (a lower surface in FIG. 5) of the disc-shaped portion 22 of the valve body 20 abuts against an inner surface side (an upper side in FIG. 5) of the end bracket 4.

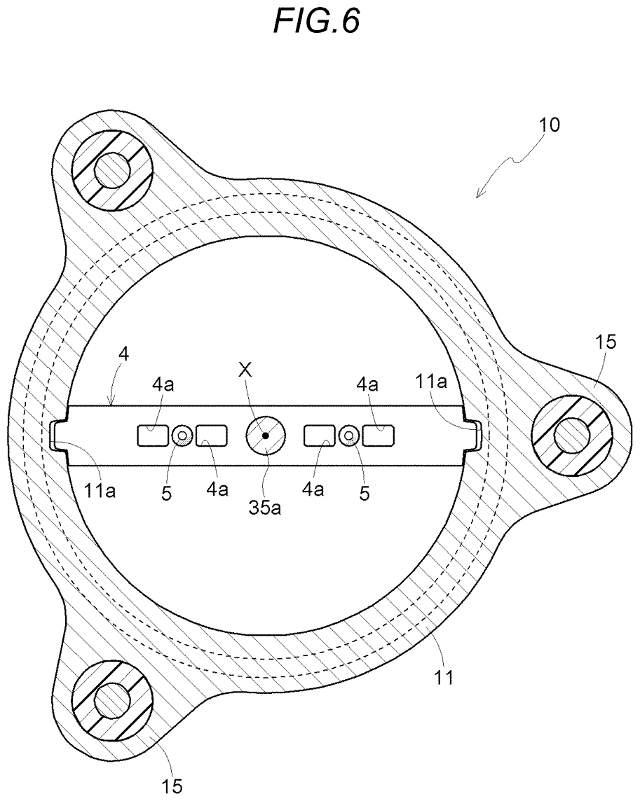

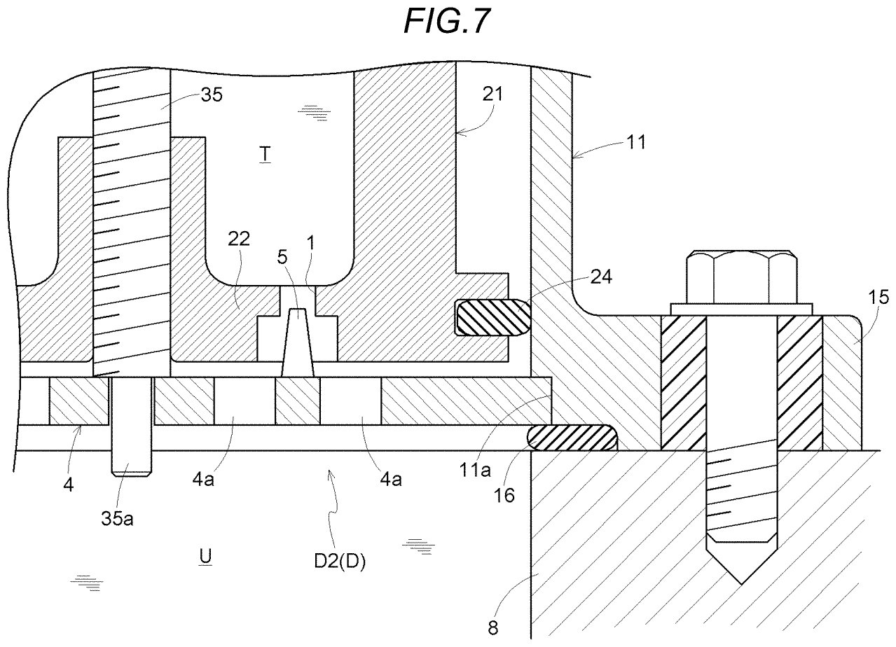

That is, as illustrated in FIGS. 6 and 7, a pair of mating recessed portions 11a is formed in an opening edge of the outflow port Pb of the housing main body 11, and both end portions of the end bracket 4 are supported in an engaged state with the mating recessed portions 11a. A hole portion into which a small-diameter portion 35a having a cylindrical shape on an outer end of the screw shaft 35 is inserted is formed in the end bracket 4. By the small-diameter portion 35a being inserted into the hole portion, the axis accuracy of the screw shaft 35 improves.

On an inner circumference of an opening edge of the housing main body 11, the end bracket 4 is disposed at a position slightly deviated from the opening edge of the housing main body 11 in a direction of the valve body 20, which is the direction along the axis X. In addition, as illustrated in FIGS. 5 and 7, a part of the seal body 16 fitted into the opening edge of the housing main body 11 is disposed to overlap an outer surface side (a lower side in FIG. 5) of the end bracket 4.

The seal body 16 is formed of an elastic material such as rubber. In a state where a flow passage configuring portion 8 is disposed to have a positional relationship of communicating with the outflow port Pb of the housing main body 11, as illustrated in FIG. 7, a part of the seal body 16 has a positional relationship of pressing the end bracket 4 in a vicinity of the mating recessed portions 11a.

The pair of second protrusions 5 is disposed at a position where the second protrusions are insertable into the corresponding through holes 1 in a posture protruding on the inner surface side of the end bracket 4 toward the direction of the valve body 20. In addition, a plurality of communication bores 4a are formed at positions in the end bracket 4, which are adjacent to the second protrusions 5, from the inner surface side to an outer surface side.

In particular, the second protrusions 5 each have a tapered shape of which a diameter decreases as going toward a tip thereof. As illustrated in FIG. 5, spaces where flow of cooling water between outer circumferences of the second protrusions 5 and the through holes 1 is possible are formed in a state where the disc-shaped portion 22 of the valve body 20 has abutted against the end bracket 4, and these spaces are configured to communicate with the communication bores 4a.

Due to this configuration, in a case where the valve body 20 is operated toward the closed position, cooling water from the out-valve space U flows from the communication bores 4a to the in-valve space T via the through holes 1, and it is possible to smoothly operate the valve body 20. Due to this operation, in a case where the valve body 20 has approached the closed position as illustrated in FIG. 7, protruding end portions of the second protrusions 5 come closer to and enter the through holes 1, and cause the through holes 1 to function as orifices. Therefore, a pressure of the cooling water in the out-valve space U becomes larger than a pressure of the cooling water in the in-valve space T, the flow rate of cooling water flowing through the through holes 1 is reduced, and also the moving speed of the valve body 20 decreases.

In the second damper unit D2, in a state where the valve body 20 has reached the closed position as illustrated in FIG. 5, the flow rate is limited, but the flow of cooling water in the through holes 1 is allowed. Therefore, a degree of reduction of the moving speed of the valve body 20 is not high compared to the first damper unit D1.

In addition, in the second damper unit D2, a pressure from the valve body 20 acts on the seal body 16 from the end bracket 4 after the valve body 20 has reached the closed position, and it is possible to compress the seal body 16. For this reason, the seal body 16 is caused to function as the damper unit D when the valve body 20 reaches the closed position and stops, and an impact when the valve body 20 comes into contact with the end bracket 4 due to elastic deformation of the seal body 16 can be absorbed.

In particular, in the opening and closing valve V, even in a state where the valve body 20 is at the closed position illustrated in FIG. 5, the flow of cooling water in the through holes 1 is allowed in the second damper unit D2. Therefore, since the flow of the cooling water in the through holes 1 is possible when operating the valve body 20 from the closed position toward the open position, the moving speed can be increased in a short time.

### Operational Effects of Embodiment

Since the first damper unit D1 and the second damper unit D2 are included as the damper unit D as described above, even in any case of a case where the valve body 20 is operated at the open position and a case where the valve body is operated at the closed position, the moving speed is decreased immediately before the valve body 20 reaches the open position and immediately before the valve body 20 reaches the closed position, and it is possible to stop the valve body 20, which can suppress an impact.

In particular, since it is possible for any one of the first damper unit D1 and the second damper unit D2 to decrease an operation velocity of the valve body 20 by reducing the flow rate of cooling water flowing between the in-valve space T of the valve body 20 and the out-valve space U, a control form can be simplified compared to controlling a driving speed of the direct current motor M.

In addition, since the second damper unit D2 not only controls the moving speed of the valve body 20 by controlling the flow rate of a fluid but also originally absorbs an impact by the end bracket 4 abutting against the seal body 16 used as a seal, it is possible to absorb the impact when the valve body 20 has reached the closed position without specially using an elastic material for buffer.

### Other Embodiments

The present invention may be configured as follows except for the embodiment described above (a configuration having the same function as in the embodiment will be assigned with the same number or the same reference sign as in the embodiment).

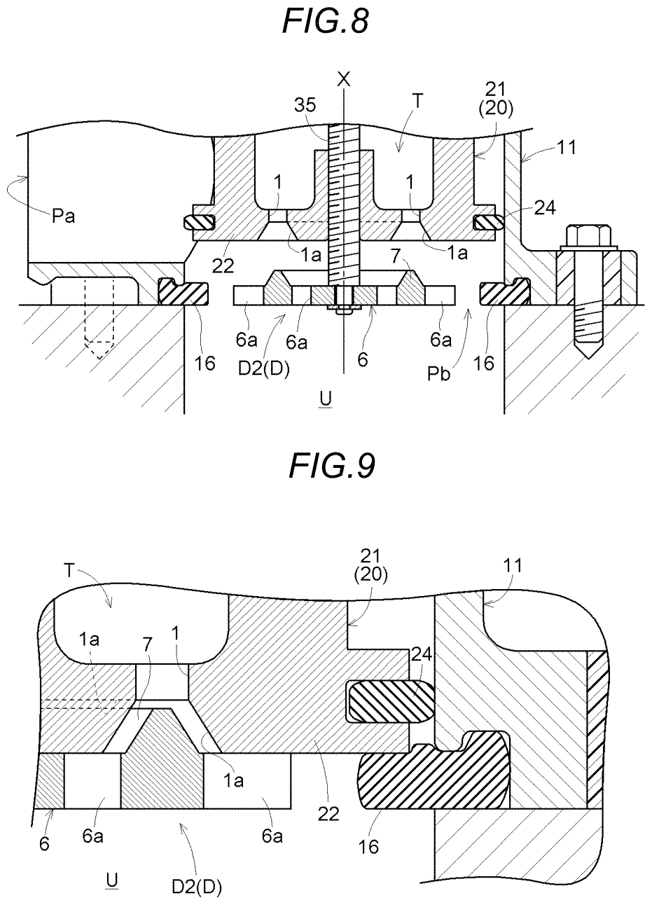

(a) As illustrated in FIGS. 8 to 10, a middle bracket 6 is supported at an outer end position of the screw shaft 35 so as to be integrally rotatable about the axis X with the screw shaft 35 (may be relatively rotatable) and not to be movable in the direction along the axis X, and the second damper unit D2 is configured by the middle bracket 6 including a restricting member.

In another Embodiment (a), the pair of through holes 1 is formed in the disc-shaped portion 22 of the valve body 20, and annular recessed portions 1a, of which a center is the axis X, are formed in the outer surface of the disc-shaped portion 22 (a lower side in FIG. 8) so as to be connected to the pair of through holes 1. In addition, the middle bracket 6 is disposed at a position opposing the annular recessed portions 1a, and an annular protrusion 7 of which a center is the axis X is formed in the middle bracket 6 such that the annular protrusion comes closer to and enters the annular recessed portions 1a.

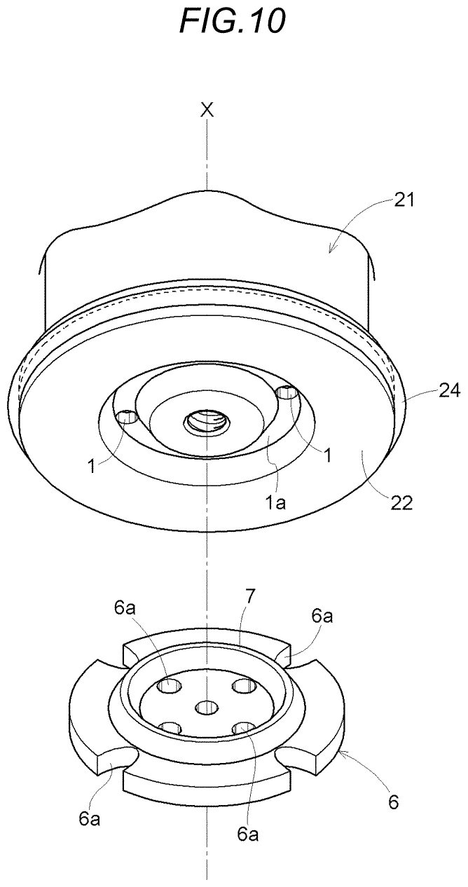

The annular recessed portions 1a each are formed such that a sectional shape thereof becomes wider as going toward a bottom portion, and the annular protrusion 7 is formed such that a sectional shape thereof becomes narrower as going toward a protruding end. In addition, each relationship is set such that an inner surface of the middle bracket 6 abuts against the outer surface of the disc-shaped portion 22 of the valve body 20 in a case where the valve body 20 has reached the closed position as illustrated in FIG. 9 and spaces that make the flow of cooling water between the annular recessed portions 1a and the annular protrusion 7 possible are formed even in this abutting state.

In the second damper unit D2 of another Embodiment (a), a plurality of communicating portions 6a ranging from the inner surface side to the outer surface side are drilled at positions in the middle bracket 6, which are adjacent to the annular protrusion 7. In particular, the annular seal body 16 is exposed to an inner circumference of the housing main body 11 so as to abut against an outer circumferential portion of the disc-shaped portion 22 of the valve body 20 in a case where the valve body 20 has reached the closed position.

Due to this configuration, in a case where the valve body 20 is operated toward the closed position, cooling water flowing from the out-valve space U to the communicating portions 6a flows to the in-valve space T via the through holes 1, and it is possible to smoothly operate the valve body 20. In a case where the valve body has approached the closed position due to this operation, the annular protrusion 7 comes closer to and enters the annular recessed portions 1a, and the amount of cooling water flowing through the through holes 1 decreases. Therefore, also the moving speed of the valve body 20 decreases.

After then, in a state where the valve body 20 has reached the closed position and the disc-shaped portion 22 of the valve body 20 has abutted against the middle bracket 6, the flow rate is limited, but the flow of cooling water in the through holes 1 is allowed. Therefore, a degree of reduction of the moving speed of the valve body 20 is not high compared to the first damper unit D1. In addition, in another Embodiment (a), in a case where the valve body 20 has reached the closed position, the moving speed of the valve body 20 is decreased since an outer circumference of the disc-shaped portion 22 of the valve body 20 comes into contact with the seal body 16 and is compressed. In another Embodiment (a), the seal body 16 functions also as the second damper unit D2.

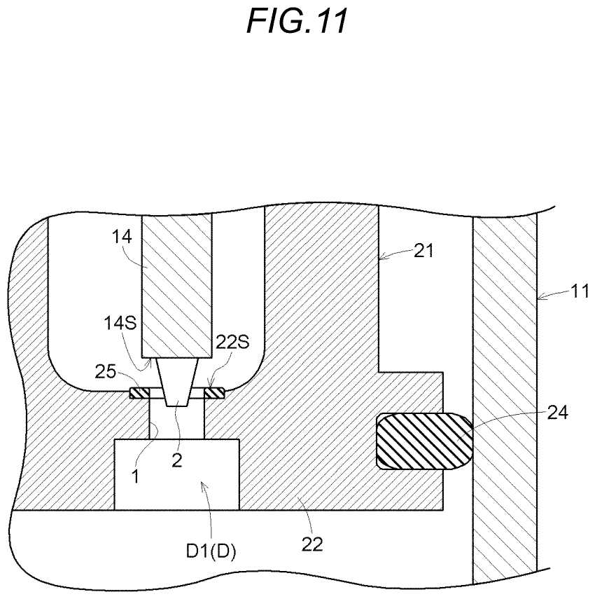

(b) As illustrated in FIG. 11, a cushioning member 25 such as a rubber sheet is included in a part of the disc-shaped portion 22 of the valve body 20, which surrounds the through holes 1, and the first damper unit D1 is configured such that a surface of the cushioning member 25, which opposes the first seal surface 14S of the sleeve 14, is set as the internal seal surface 22S.

In another Embodiment (b), in a case where the valve body 20 has approached the open position, the protruding end portions of the first protrusions 2 come closer to and enter the through holes 1, and cause the through holes 1 to function as orifices. Therefore, the flow rate of cooling water flowing through the through holes 1 is reduced, and also the moving speed of the valve body 20 decreases.

After then, immediately before the valve body 20 reaches the open position, the interval between the first seal surface 14S and the internal seal surface 22S is extremely small, and the flow of cooling water in this part is limited. As a result, the moving speed of the valve body 20 significantly decreases, and the valve body 20 is maintained at the open position by the first seal surface 14S and the internal seal surface 22S abutting against each other in the end. In particular, an impact is suppressed by the first seal surface 14S of the sleeve 14 abutting against the internal seal surface 22S of the cushioning member 25 at a time point when the valve body 20 has reached the open position. It is possible to completely block the flow of cooling water in the through holes 1 by the first seal surface 14S abutting against the internal seal surface 22S of the cushioning member 25 as described above.

(c) The damper unit D is configured by using a buffer member such as rubber abutting against the valve body 20 when the valve body 20 has reached the closed position and using a buffer member such as rubber abutting against a member integrally operating with the valve body 20 when the valve body 20 has reached the closed position.

As a specific form of another Embodiment (c), a structure in which the end bracket 4 integrally operating with the valve body 20 abuts against the seal body 16 after the valve body 20 has reached the closed position, or a structure in which the seal body 16 abuts against the valve body 20 when the valve body 20 has reached the closed position as described in another Embodiment (a) can be adopted as described in the embodiment. In particular, instead of a configuration of using the seal body 16 as a buffer member, a configuration of using dedicated rubber or a spring for cushioning may be adopted.

In another Embodiment (c), a shape or disposition of the buffer member is not limited to the embodiment or another Embodiment (a), and a configuration can be simplified without using a configuration of controlling the amount of cooling water flowing between the in-valve space T of the valve body 20 and the out-valve space U.

(d) Although the communication bores 4a penetrating the end bracket 4 are formed in the end bracket 4 in the vicinity of the second protrusions 5 as the second damper unit D2 in the embodiment, instead of this, a configuration where the communication bores 4a penetrating the second protrusions 5 (penetrating in an up-and-down direction in FIG. 5) are formed may be adopted. In addition, by forming grooves facing the vicinity of the second protrusions 5 in a width direction in the inner surface side (the upper side in FIG. 5) of the end bracket 4, instead of the communication bores 4a, it is also possible to adopt a configuration where cooling water flows through the grooves.

(e) The through holes 1 each are configured to have the smallest diameter at a middle position in the direction along the axis X, to have a diameter that increases as going toward a position close to the in-valve space T with the position where the diameter is the smallest as described above as reference, and to have a diameter that increases as going toward a position close to the out-valve space U with the position where the diameter is the smallest as reference.

By setting the shape of each of the through holes 1 in this manner, it is possible to efficiently suppress the flow of cooling water when the through holes 1 function as orifices. In addition, in the configuration of still another Embodiment (e), for example, it is also possible to form any of the first protrusions 2 of the first damper unit D1 and the second protrusions 5 of the second damper unit D2 to have a straight rod shape.

The present invention can be used in an opening and closing valve in which a valve body is operated by a direct current motor.

A feature of an opening and closing valve according to an aspect of this disclosure resides in that the opening and closing valve includes a housing that has an internal space formed to have a posture along an axis and has an inflow port and an outflow port which communicate with each other via the internal space, a valve body that is switchable between a closed position where flow of a fluid between the inflow port and the outflow port is blocked and an open position where the flow of the fluid between the inflow port and the outflow port is allowed, by being operated in the internal space of the housing along the axis, a direct current motor that operates the valve body in a direction along the axis, and a damper unit that decreases a moving speed of the valve body immediately before the valve body reaches at least one of the open position and the closed position by a drive force of the direct current motor.

According to the feature, the flow of the fluid between the inflow port and the outflow port is blocked by setting the valve body at the closed position by the drive force of the direct current motor. In addition, the flow of the fluid between the inflow port and the outflow port is allowed by setting the valve body at the open position. In the configuration, since the damper unit decreases the moving speed of the valve body immediately before the valve body reaches any one of the open position and the closed position, it is possible to suppress an impact when the valve body has reached an operating limit even when at least one of the closed position and the open position is set to the operating limit of the valve body.

Therefore, the opening and closing valve that can suppress the generation of an impact even though the valve body reaches the operating limit is configured.

As another configuration, the valve body may have an in-valve space into which the fluid in the internal space of the housing is allowed to flow, the valve body is configured such that when the valve body is set at the open position, the fluid from the inflow port may pass through an out-valve space in the internal space, which is outside the valve body, and flow to the outflow port, the valve body may have a communicating structure that reduces a pressure difference between the fluid in the out-valve space and the fluid in the in-valve space when the valve body operates along the axis, and the damper unit may increase the pressure difference immediately before the valve body reaches the closed position or the open position.

According to this configuration, smooth operation of the valve body is realized by the communicating structure reducing the pressure difference between the in-valve space and the out-valve space when the valve body operates. Since the damper unit increases the pressure difference between the in-valve space and the out-valve space immediately before the valve body reaches the closed position or the open position, it is possible to reduce the operation velocity of the valve body immediately before the valve body reaches the closed position or the open position. Accordingly, an impact when the valve body has reached the closed position or the open position can be suppressed without using a buffer member such as rubber as the damper unit.

As another configuration, the communicating structure may be a through hole that allows the flow of the fluid between the out-valve space and the in-valve space to reduce the pressure difference between the out-valve space and the in-valve space when the valve body operates along the axis, and the damper unit may be configured by a protrusion that reduces a flow rate of the fluid flowing through the through hole by reaching a position close to the through hole immediately before the valve body reaches the closed position or the open position.

According to this configuration, the communication bore reduces the pressure difference since the flow of the fluid between the in-valve space and the out-valve space is made possible when the valve body operates, and thus it is possible to smoothly operate the valve body. The flow rate of the fluid in the through hole is limited by the protrusion coming closer to the through hole immediately before the valve body reaches the closed position or the open position. As a result, it is possible to reduce the operation velocity of the valve body immediately before the valve body reaches the closed position or the open position.

As another configuration, the through hole may have a portion formed to have a diameter that becomes smaller as going toward a position close to the protrusion, or the protrusion may have a portion formed to have a diameter that becomes smaller as going toward a position close to the through hole.

According to this configuration, as an amount by which the protrusion has entered the through hole increases, the flow rate of the fluid flowing through the through hole decreases, making possible for the through hole to function as an orifice. Accordingly, as the valve body approaches the closed position or the open position, the moving speed of the valve body reduces, and sudden deceleration of the valve body can be suppressed.

As another configuration, the through hole may be completely closed at a time point when the valve body has reached the open position.

According to this configuration, in a case where the valve body is operated to the open position, the flow of the fluid between the in-valve space of the valve body and the out-valve space is completely blocked, and thus an impact can be made extremely small.

As another configuration, the housing may include a screw shaft that is coaxial with the axis, the valve body may include a female screw portion that is screwed with the screw shaft, the direct current motor may rotationally drive the screw shaft, and the protrusion may be provided in a bracket that is supported to be non-rotatable relatively to the housing.

According to this configuration, it is possible to move the valve body by the direct current motor rotationally driving the screw shaft. In addition, with the operation of the valve body, the protrusion provided in the bracket supported to be non-rotatable relatively to the housing can come closer to the through hole.

As another configuration, the housing may include a screw shaft that is coaxial with the axis, the valve body may include a female screw portion that is screwed with the screw shaft, the direct current motor may rotationally drive the screw shaft, and the protrusion may be provided in a bracket that is supported to be rotatable integrally with the screw shaft at an outer end position of the screw shaft penetrating the valve body.

According to this configuration, it is possible to move the valve body by the direct current motor rotationally driving the screw shaft. In addition, with the operation of the valve body, the protrusion provided in the bracket supported at the outer end position of the screw shaft can come closer to the through hole.

As another configuration, the through hole may have a portion formed to have a diameter that becomes larger as going toward a position close to the protrusion, or the protrusion may have a portion formed to have a diameter that becomes smaller as going toward a position close to the through hole.

According to this configuration, for example, in a case where the valve body is operated to the closed position, a portion of the protrusion, which has a small diameter, is inserted into a portion of the through hole, which has a large diameter, and slight flow of the fluid between the out-valve space and the in-valve space is allowed.

As another configuration, the valve body may be configured to allow slight flow of the fluid in the through hole at a time point when the valve body has reached the closed position.

According to this configuration, since the fluid slightly flows in the through hole at a time point when the valve body has reached the closed position, the flow of a slight amount of the fluid is possible between the out-valve space and the in-valve space. For this reason, when operating the valve body from the closed position to the open position, the flow of the fluid is easily made between the in-valve space and the out-valve space, and it is possible to rapidly operate the valve body.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An opening and closing valve comprising:
a housing that has an internal space formed to have a posture along an axis and has an inflow port and an outflow port which communicate with each other via the internal space;
a valve body that is switchable between a closed position where flow of a fluid between the inflow port and the outflow port is blocked and an open position where the flow of the fluid between the inflow port and the outflow port is allowed, by being operated in the internal space of the housing along the axis;
a direct current motor that operates the valve body in a direction along the axis; and
a damper unit that decreases a moving speed of the valve body immediately before the valve body reaches at least one of the open position and the closed position by a drive force of the direct current motor.

2. The opening and closing valve according to claim 1, wherein
the valve body has an in-valve space into which the fluid in the internal space of the housing is allowed to flow,
the valve body is configured such that, when the valve body is set at the open position, the fluid from the inflow port passes through an out-valve space in the internal space, which is outside the valve body, and flows to the outflow port,
the valve body has a communicating structure that reduces a pressure difference between the fluid in the out-valve space and the fluid in the in-valve space when the valve body operates along the axis, and
the damper unit increases the pressure difference immediately before the valve body reaches the closed position or the open position.

3. The opening and closing valve according to claim 2, wherein
the communicating structure is a through hole that allows the flow of the fluid between the out-valve space and the in-valve space to reduce the pressure difference between the out-valve space and the in-valve space when the valve body operates along the axis, and
the damper unit is configured by a protrusion that reduces a flow rate of the fluid flowing through the through hole by reaching a position close to the through hole immediately before the valve body reaches the closed position or the open position.

4. The opening and closing valve according to claim 3, wherein
the through hole has a portion formed to have a diameter that becomes smaller as going toward a position close to the protrusion, or the protrusion has a portion formed to have a diameter that becomes smaller as going toward a position close to the through hole.

5. The opening and closing valve according to claim 3, wherein
the through hole is completely closed at a time point when the valve body has reached the open position.

6. The opening and closing valve according to claim 4, wherein
the through hole is completely closed at a time point when the valve body has reached the open position.

7. The opening and closing valve according to claim 3, wherein
the housing includes a screw shaft that is coaxial with the axis,
the valve body includes a female screw portion that is screwed with the screw shaft,
the direct current motor rotationally drives the screw shaft, and
the protrusion is provided in a bracket that is supported to be non-rotatable relatively to the housing.

8. The opening and closing valve according to claim 3, wherein
the housing includes a screw shaft that is coaxial with the axis,
the valve body includes a female screw portion that is screwed with the screw shaft,
the direct current motor rotationally drives the screw shaft, and
the protrusion is provided in a bracket that is supported to be rotatable integrally with the screw shaft at an outer end position of the screw shaft penetrating the valve body.

9. The opening and closing valve according to claim 6, wherein
the through hole has a portion formed to have a diameter that becomes larger as going toward a position close to the protrusion, or the protrusion has a portion formed to have a diameter that becomes smaller as going toward a position close to the through hole.

10. The opening and closing valve according to claim 7, wherein
the valve body is configured to allow slight flow of the fluid in the through hole at a time point when the valve body has reached the closed position.

11. The opening and closing valve according to claim 9, wherein
the valve body is configured to allow slight flow of the fluid in the through hole at a time point when the valve body has reached the closed position.
